(19) United States
(12) Patent Application Publication
(10) Pub. No.: US 2012/0048864 A1
(43) Pub. Date: Mar. 1, 2012

(54) Cookware made from Five-layered Composite Sheet

(76) Inventor: Arlo Lin, Taichung City (TW)

(21) Appl. No.: 13/166,916

(22) Filed: Jun. 23, 2011

(30) Foreign Application Priority Data
Sep. 1, 2010 (TW) 99216955

(51) Int. Cl. A47J 27/00; B32B 15/01

(52) U.S. Cl. 220/573.1; 428/653

(57) ABSTRACT

A cookware made from a five-layered composite sheet includes a core layer of carbon steel, two layers of aluminum bonded to the core layer such that the core layer is sandwiched between the two layers of aluminum, two layers of stainless steel bonded on the two layers of aluminum respectively and defining two outer layers of the cookware.

### BACKGROUND OF THE INVENTION

1. Field of the Invention

The present invention relates to a cookware and, in particular, to a cookware that is made from a five-layered composite sheet.

2. Description of the Related Art

Taiwan Pat. No. M377168 discloses a cookware made from multi-layered composite sheet. The multi-layered composite sheet includes an upper metal layer, a middle metal layer, and a bottom metal layer, with the middle metal layer sandwiched between the upper and bottom metal layers. Both the upper and bottom metal layers are stainless steel. The middle layer is an alloy including aluminum, magnesium, and copper. The problem that the cookware suffers is that it can not eliminate hot spots across a cooking surface of the cookware and an unsatisfactory heat-retaining property.

The present invention is, therefore, intended to obviate or at least alleviate the problems encountered in the prior art.

### SUMMARY OF THE INVENTION

According to the present invention, a cookware made from a five-layered composite sheet includes a core layer of carbon steel. Further, two layers of aluminum are bonded to upper and lower sides of the core layer of carbon steel. The core layer of carbon steel is sandwiched between the two layers of aluminum. Further, two layers of stainless steel are bonded on the two layers of aluminum respectively and define two outer layers of the cookware. The core layer of carbon steel and the two layers of aluminum are sandwiched between the two layers of stainless steel.

It is an object of the present invention to provide a cookware made from a five-layered composite sheet.

It is also an object of the present invention to provide a cookware embodied as a cooking plate for a stove.

It is another object of the present invention to provide a cookware and upon heating the cookware from one of the two layers of stainless steel, heat is quickly conducted from one of the two layers of stainless steel to the core layer of carbon steel, and the core layer of carbon steel retards heat flow in a transverse direction to the layers of aluminum so as to keep heat and to cause heat to distribute in a lateral direction to eliminate hot spots across the cooking surface of the cookware.

It is a yet another object of the invention to provide a cookware with easy clean outer surfaces.

It is a further object of the invention to provide a cookware with excellent corrosion resistance.

It is a further object of the invention to provide a cookware with a satisfactory structural resistance to impact.

It is a further object of the invention to provide a durable cookware.

### BRIEF DESCRIPTION OF THE DRAWINGS

FIG. 1 is a perspective view of a cookware made from a five-layered composite sheet in accordance with the present invention.

FIG. 2 is a cross-sectional view of the cookware of FIG. 1.

FIG. 3 is a partial, enlarged cross-sectional view of FIG. 2.

FIG. 4 is a perspective view of a stove including the cookware of FIG. 1.

FIG. 5 is an exploded perspective view of FIG. 4.

### DETAILED DESCRIPTION OF THE PREFERRED EMBODIMENT

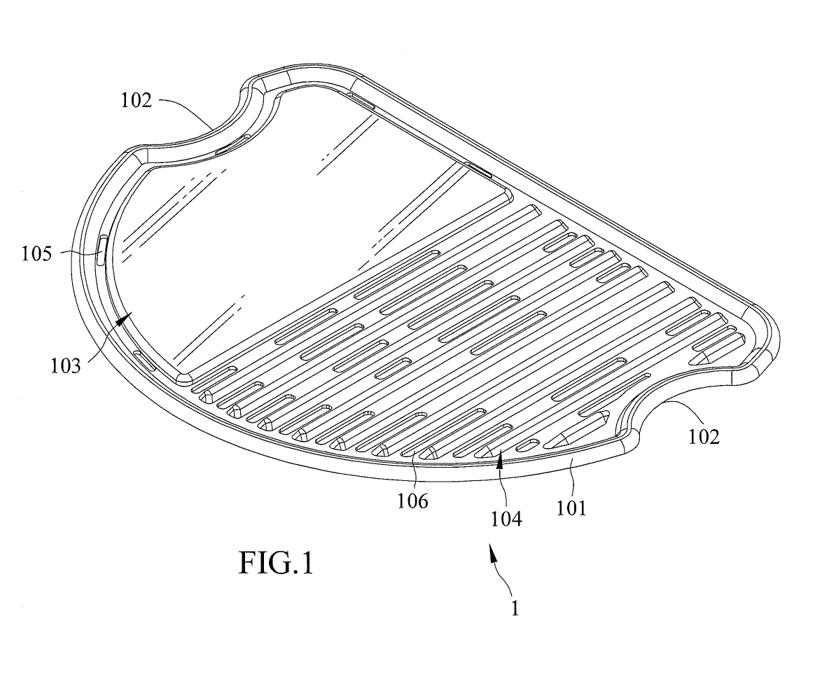

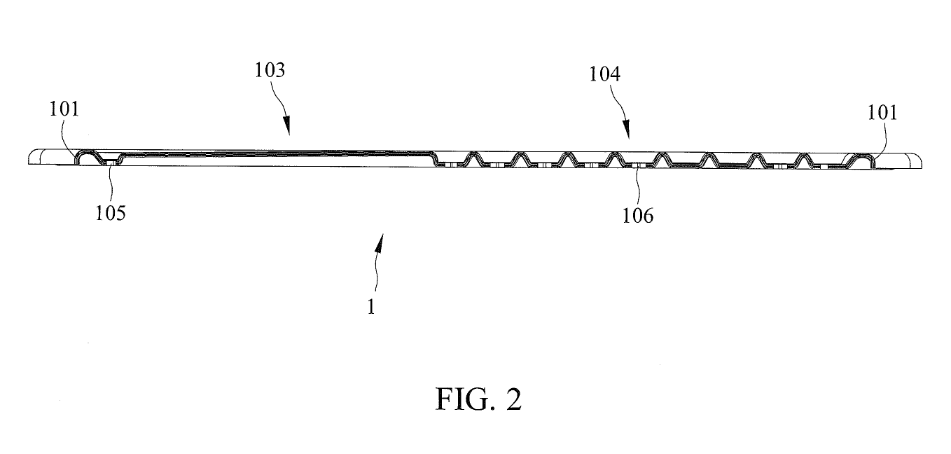

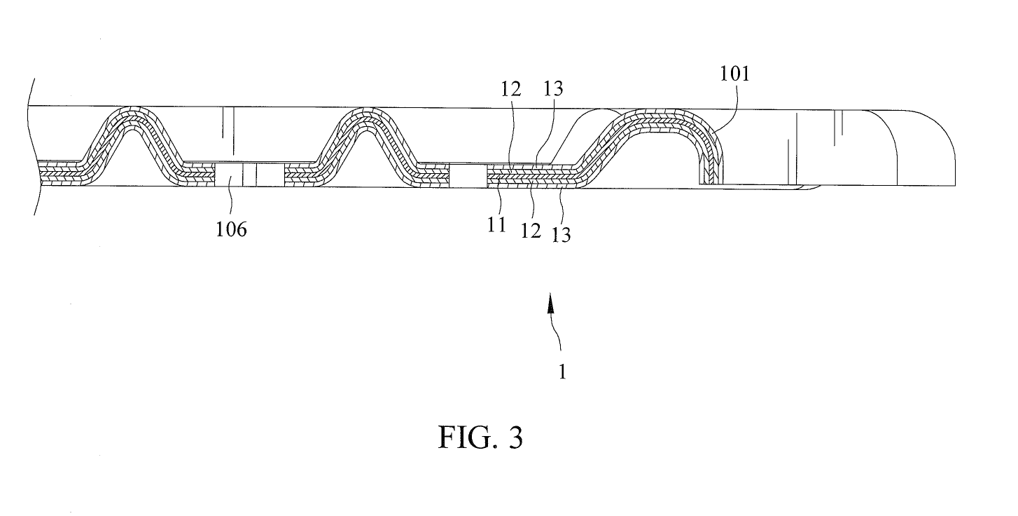

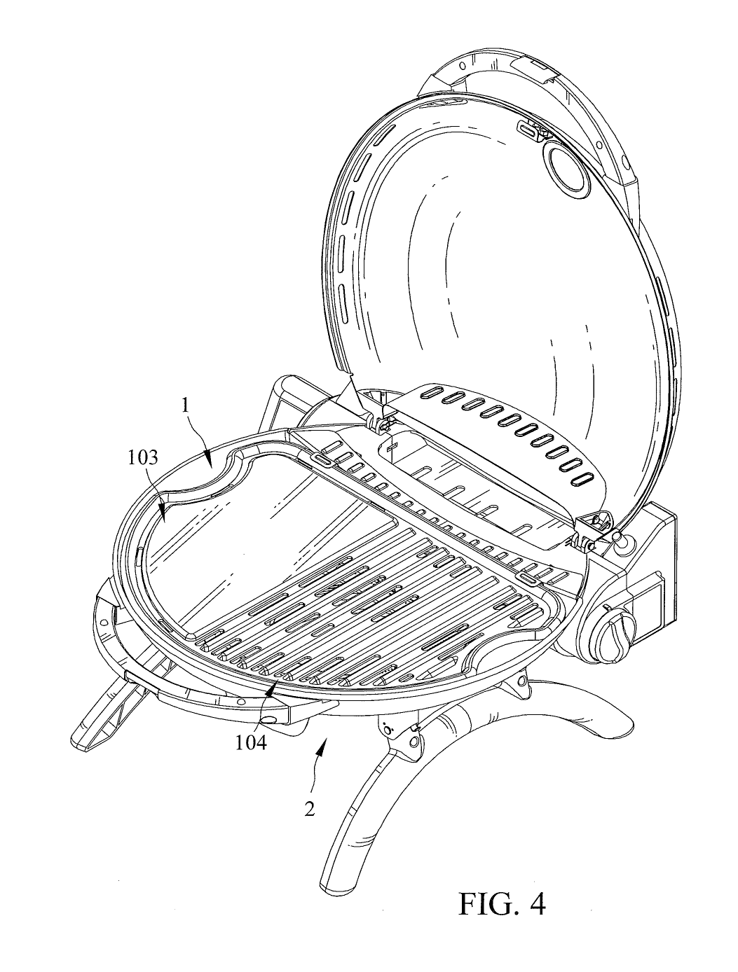

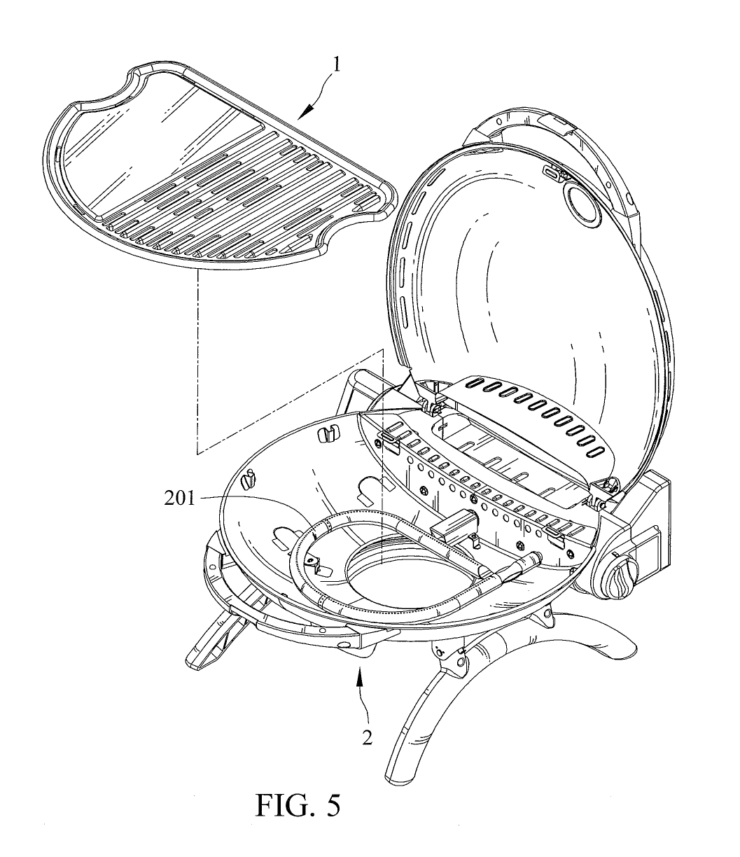

FIGS. 1 through 5 show a cookware 1 made from a five-layered composite sheet in accordance with the present invention.

The cookware 1 includes a core layer of carbon steel 11. Further, two layers of aluminum 12 are bonded to upper and lower sides of the core layer carbon steel 11. The core layer of carbon steel 11 is sandwiched between the two layers of aluminum 12. Further, two layers of stainless steel 13 are bonded on the two layers of aluminum 12 respectively and define two outer layers of the cookware 1. The core layer of carbon steel 11 and the two layers of aluminum 12 are sandwiched between the two layers of stainless steel 13.

Each of the two layers of stainless steel 13 has a thermal conductivity of 16, 17, 19 W/mK at 25, 125, 225° C., respectively. Each of the two layers of aluminum 12 has a thermal conductivity of 250, 255, 250 W/mK at 25, 125, 225° C., respectively. The core layer of carbon steel 11 has a thermal conductivity at 54, 51, 57 W/mK at 25, 125, 225° C., respectively.

Preferably, each of the two layers of aluminum 12 is pure aluminum.

Preferably, each the two layers of aluminum 12 is aluminum alloy.

The cookware 1 is embodied as a cooking plate for a stove 2. The cookware 1 includes one of the two layers of stainless steel 13 defining a cooking surface. Furthermore, the cookware 1 includes a circumferential edge 101 circumscribing the cooking surface and including a curved cross section. Additionally, the circumferential edge 101 includes at least one length defining a concave contour 102 such that the cookware 1 is adapted to have the concave contour 102 spacing from a peripheral of the stove 2 with a gap. The gap is adapted to facilitate removal and placing of the cookware 1 on the stove 2. The cooking surface defines a first cooking area 103 including a flat cross section and a second cooking area 104 including a non-flat cross section. The second cooking area 104 forms a plurality of ridges and each includes a curved cross section. The plurality of ridges are disposed parallel to each other. Moreover, the cookware 1 includes a plurality of first holes 105 and second holes 106 defined thereon and extending therethrough. The plurality of first holes 105 are disposed along a peripheral edge of the first cooking area 103. The plurality of second holes 106 are disposed in the second cooking area 104.

Additionally, the stove 2 includes a cavity with an opening and a heating source 201 disposed in the cavity.

When the cookware 1 is used on the stove 2 and is heated, one of the two layers of stainless steel 13 adjacent to the heating source 201 of the stove 2 receives heat directly from the heating source 201, and heat is emitted from the other of the two layers of stainless steel 13 through one of the two layers of aluminum 12, the core layer of carbon steel 11, and the other of the two layers of aluminum 12 successively. In this case, the other of the two layers of stainless steel 13 serves as the cooking surface of the cookware 1. Additionally, the plurality of first holes 105 and the plurality of second holes 106 serve as oil drain holes.

In view of the forgoing, upon heating the cookware 1 from one of the two layers of stainless steel 13, heat is quickly conducted from one of the two layers of stainless steel 13 to the core layer of carbon steel 11 because this layer of aluminum 12 has a relatively higher thermal conductivity than the layer of stainless steel 13, and the core layer of carbon steel 11 retards heat flow in a transverse direction to the layers of aluminum 12 so as to keep heat and to cause heat to distribute in a lateral direction to eliminate hot spots across the cooking surface of the cookware 1, defined by the other of the two layers of stainless steel 13. Additionally, because the outer layers of the cookware 1 are stainless steel, it is easy to clean and wash the cookware 1 and it is difficult for bacteria and other micro-organisms to adhere and survive, and the cookware 1 thus has excellent corrosion resistance and has a satisfactory structural resistance to impact and is durable.

While the specific embodiment has been illustrated and described, numerous modifications come to mind without significantly departing from the spirit of invention, and the scope of invention is only limited by the scope of the accompanying claims.

What is claimed is:

1. A cookware made from a five-layered composite sheet comprising:
a core layer of carbon steel;
two layers of aluminum bonded to upper and lower sides of the core layer of carbon steel, with the core layer of carbon steel sandwiched between the two layers of aluminum;
two layers of stainless steel bonded on the two layers of aluminum respectively and defining two outer layers of the cookware, with the core layer of carbon steel and the two layers of aluminum sandwiched between the two layers of stainless steel;
whereby a five layer symmetrical composite metal cookware is provided.

2. The cookware as claimed in claim 1, wherein each of the two layers of aluminum is pure aluminum.

3. The cookware as claimed in claim 1, wherein each the two layers of aluminum is aluminum alloy.

4. The cookware as claimed in claim 1, with the cookware embodied as a cooking plate for a stove, with the cookware including one of the two layers of stainless steel defining a cooking surface.

5. The cookware as claimed in claim 4, with the cookware including a circumferential edge circumscribing the cooking surface and including a curved cross section.

6. The cookware as claimed in claim 1, wherein the cooking surface defines a first cooking area including a flat cross section and a second cooking area including a non-flat cross section and forming a plurality of ridges, with each ridge including a curved cross section.

7. The cookware as claimed in claim 5, wherein the circumferential edge includes at least one length defining a concave contour, with the cookware adapted to have the concave contour spacing from a peripheral of the stove with a gap, with the gap adapted to facilitate removal and placing of the cookware on the stove.

8. The cookware as claimed in claim 4, with the cookware including a plurality of first holes and second holes defined thereon and extending therethrough, with the plurality of first holes disposed along a peripheral edge of the first cooking area and the plurality of second holes disposed in the second cooking area, respectively.

9. The cookware as claimed in claim 6, with the cookware including a plurality of first holes and second holes defined thereon and extending therethrough, with the plurality of first holes disposed along a peripheral edge of the first cooking area and the plurality of second holes disposed in the second cooking area, respectively, with each of the plurality of ridges disposed adjacent to at least one second hole.
